(19) United States
(12) Patent Application Publication
(10) Pub. No.: US 2018/0103796 A1
(43) Pub. Date: Apr. 19, 2018

(54) COOKING CONTAINER WITH STEAM ELIMINATING FUNCTION

(71) Applicant: THREE STAR CO., LTD., Incheon (KR)

(72) Inventor: Chang Gi PARK, Incheon (KR)

(73) Assignee: THREE STAR CO., LTD., Incheon (KR)

(21) Appl. No.: 15/320,486

(22) PCT Filed: Jun. 15, 2016
(86) PCT No.: PCT/KR2016/006369

§ 371 Date: Dec. 20, 2016

(30) Foreign Application Priority Data
Jun. 15, 2015 (KR) 10-2015-0084366

(51) Int. Cl. A47J 36/38; A47J 27/00; A47J 27/04; A47J 36/28; A47J 36/24

(52) U.S. Cl. CPC A47J 36/38; A47J 27/002; A47J 2027/043; A47J 36/28; A47J 36/2405; A47J 27/04

(57) ABSTRACT

The invention is a cooking container with steam eliminating function comprising: an outer container 10 and having an lid 13 and a steam vent 14; an inner container 20 being inserted in the outer container 10; a heating material 30 disposed in the outer container 10 and generating heat by reacting with water; a steam blocking means 40 including a cooling body 41 having a cooling chamber 42a to be filled with cooling means 44, and a steam exhaust pipe 45 provided in the cooling chamber 42a of the cooling body 41 and a part of it being exposed outside of the cooling body 41 and the exposed end of it being removably engaged into the steam vent 14 of the outer container 10.

### TECHNICAL FIELD

The present invention relates to a cooking container with steam eliminating function, and more particularly, to a cooking container with steam eliminating function being capable of eliminating the steam generated while cooking foods.

### BACKGROUND ART

Recently the outdoor activities such as fishing, climbing and camping are increasing, so outdoor cooking is also increasing. But carrying or using an equipment or a cooking device is strictly restricted due to the fire risk. Considering this situation, a cooking container is suggested on Korean patent laid-open N.10-2005-110514 which can use a safe heating material which can generate heats when contacting water to warm the already cooked foods by steam, without use of fuel such as oil, gas or wood which may cause fire. This cooking container comprises of metal heating container, a food container received in the metal heating container, and a heating material being filled in the heating container and generating heats of high temperature by the heat generation reaction when contacting water. But this cooking container generate steam exhausting noise during cooking, and the steam obscures view of people, and it may incur the safety accident such as burn, and position of soldiers can be easily exposed to the enemy. And the metal food container is heavy, so the weight of bag packing the food container is increased, the cost is high, and it is cumbersome to wash the container after using it.

### SUMMARY OF THE INVENTION

### Technical Problem

To solve the above problems, it is an object of the present invention to provide a cooking container with steam eliminating function which is advantageous in that steam is not exhausted during cooking to prevent the steam noise and obscuring view, and it also prevent safety accident such as fire burn, and it can lessen the weight and reduce the cost and it is convenient and hygienic because it need not washing, and reduce the possibility of exposure of soldier's position, and it can save cooking time because it can be cooked in the bag pack during in motion or walking, so it can improve the ability of military or civil execution of operation.

### Technical Solution

According to an aspect of the present invention, there is provided a cooking container with steam eliminating function comprising: an outer container 10 to be filled with water and having an openable upper part and a steam vent 14 on one side; an inner container 20 to be filled with foods and being inserted in the outer container 10; a heating material 30 disposed in the outer container 10 and generating heat by reacting with water; a steam blocking means 40 including a cooling body 41 having a cooling chamber 42a to be filled with cooling means 44 such as ice, snow or water, and a steam exhaust pipe 45 provided in the cooling chamber 42a of the cooling body 41 and a part of it being exposed outside of the cooling body 41 and the exposed end of it being removably engaged into the steam vent 14 of the outer container 10, wherein the steam generated in the outer container 10 flow through the steam exhaust pipe 45 and condensed by the cooling means 44 in the cooling chamber 44.

According to another aspect of the present invention, the other end of the steam exhaust pipe 45 of the steam blocking means 40 penetrates the cooling body 41 to be exposed outside, and the exposed end of the steam exhaust pipe 45 is connected to an exhaust container 46 in which the water condensed from the steam is collected.

According to another aspect of the present invention, at least the inner container 20 among the outer and inner container 10, 20 comprises a zipper bag having a zipper 24 on the upper opening 21 and a steam exhaust valve 25 below the zipper 24.

According to another aspect of the present invention, the cooking container further comprises an outer lid 12 on the upper side of the outer container 10, a pair of up-down guiders 50 disposed on the opposite outer wall of the outer container 10, a handle 60 having a horizontal portion 61 and upright portions 62 bent from the both ends of the horizontal portion 61 and engaged with the up-down guiders 50 movably up and down and having a threaded part 63 in the upright portion, a nut body 70 engaged with the threaded part 63 of the upright portion 62 of the handle 60, and a spring 80 inserted on the upright portions 62 between the nut body 70 and the up-down guider 50.

### Advantageous Effects

According to the present invention as described above, as the steam generated in the inner container 20 by the heating material 30 in the outer container 10 passes through the cooling chamber 42 of the steam blocking means 40 filled with cooling means 44 and changed into water, so that the exhausting of steam itself is prevented. Therefore, in the field, steam exhausting noise and steam smoke are prevented, so the steam noise or obscuring view are effectively avoided. And, in the room, the indoor atmosphere is more pleasant and the window glass is prevented from being obscured by the steam, so there is no need to open the window. And burning by the high temperature steam is also prevented. And the soldier may not be exposed to the enemy in visual or auditory respect. And, in winter, snow, ice or cool water can be used as the cooling means 44, and it can be heated by steam to obtain a hot water in the field.

And, the steam can be cooled by the steam blocking means 40 to become water and it is collected in the exhaust container 46, so it does not need to stay in one location to cook foods, instead, it is possible to cook foods as the cooking container is in the bag to save the cooking time and the speedy military operation is possible.

And at least the inner container 20 is made of zipper bag 20, so the weight and volume of the cooking container can be reduced, so carrying it is easy and the cost is reduced, and as the cooking container is disposable, it is not necessary to wash it, so it can be used hygienically in the field.

And the upright portion 62 of the handle 52 is moved up-down from the outer container 10, the horizontal portion 60 of the handle 60 can be positioned closely to the lid 13 of the outer container 10, the cooking container can be reduced into compact size to be easy in storing and carrying. In this case, as the has a threaded part 63 and it can be screwed up by the nut body 70 and the spring 80 is compressed, then the horizontal portion 61 of the handle 60 is pressed onto the lid 13 and the air-tightness of the lid 13 can be increased.

### BRIEF DESCRIPTION OF THE DRAWINGS

FIG. 1 is a perspective view illustrating the first embodiment of the invention

FIG. 2 is an exploded perspective view of the above first embodiment of the invention

FIG. 3 is a side sectional view of the above first embodiment of the invention

FIG. 4 is an exploded perspective view of the second embodiment of the invention

FIG. 5 is a view illustrating the steam exhaust valve

FIG. 6 is a side sectional view of the above second embodiment of the invention

FIG. 7 is a perspective view illustrating the third embodiment of the invention

FIG. 8 is a side sectional view of the above third embodiment of the invention

FIG. 9 is a view illustrating the up-down of the handle of the third embodiment of the invention

FIG. 10 is a view illustrating the swing of the handle of the third embodiment of the invention

FIG. 11 is a view illustrating the third embodiment of the invention packed in the bag

FIG. 12 is a side sectional view of the fourth embodiment of the invention

### BEST MODE

The objects, features or advantages of the invention will be clearly understood by the detailed explanation of the preferred embodiments accompanied by the drawings.

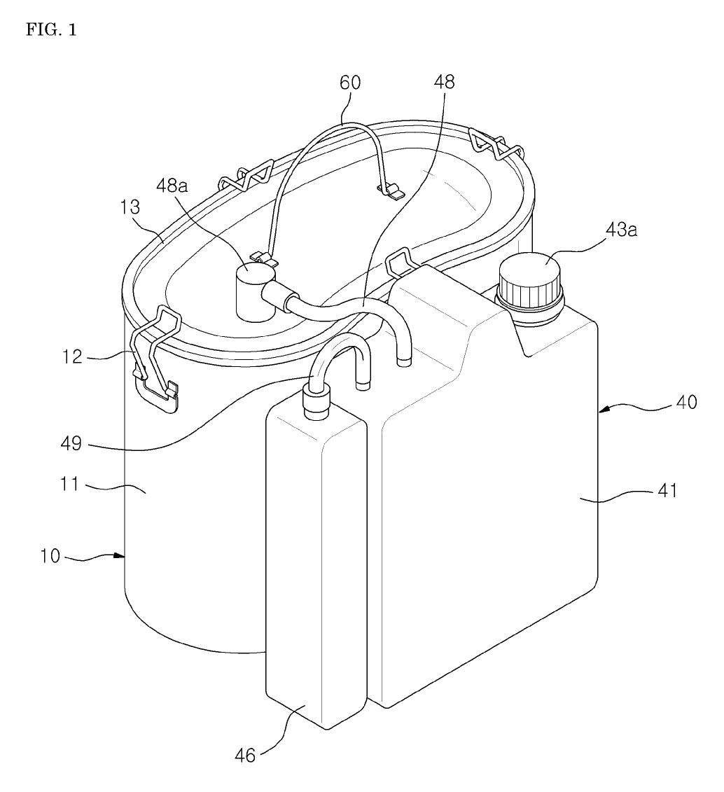

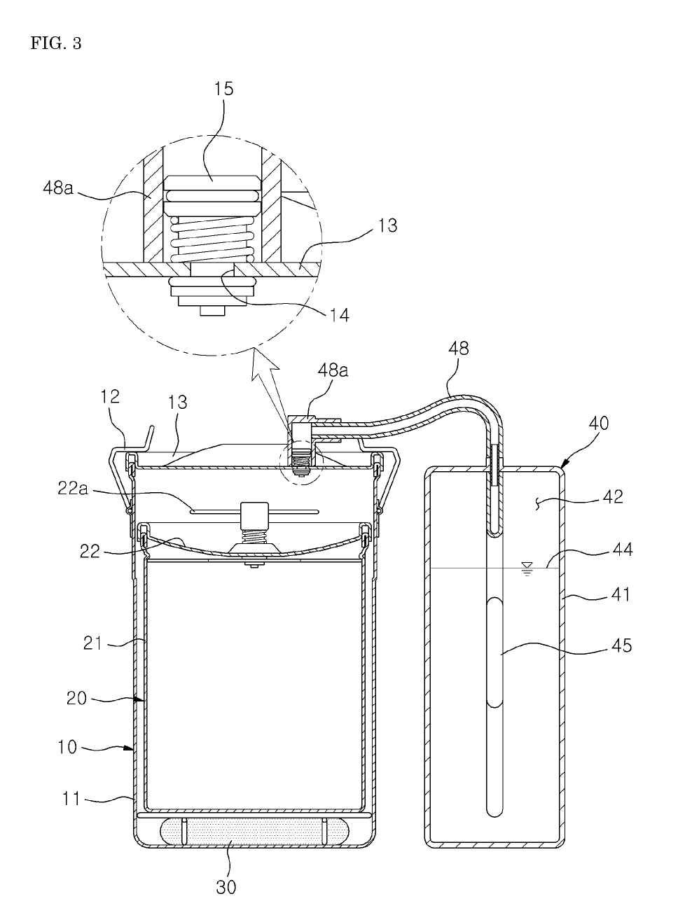

Referring to FIG. 1 to FIG. 3, the first embodiment of the invention comprises an outer container 10, and an inner container 20 inserted in the outer container 10, a heating material 30 provided in the outer container 10, and a steam blocking means 40 to prevent the steam generated in the outer container 10 from exhausting outside.

The outer container 10 houses the inner container 20 and the heating material 30, and comprises an outer container body 11 and the outer lid 13 on the upper side of it. A clamping member 12 is provide on the outer container body 11 to clamp the outer lid 13 on the outer container body 11. A steam vent 14 is formed on the lid 13 to exhaust steam, and a pressure regulation valve 14 is provided on the steam vent 14. A handle 60 is provided on the lid 13. The inner container 20 is seated in the outer container 10 and contains the foods. The inner container 20 comprises an inner container body 21 and the inner lid 22. The inner lid 22 has an auxiliary handle 22a to draw the inner container 20 from the outer container 10. The shape of the outer container 10 and the inner container 20 can be variously changed. But they are preferably made of stainless steel.

The heating material 30 can be properly chosen from the known materials that can generate heat by reacting with water, for example, they may be quicklime, oxidized steel or magnesia. This heating material 30 is formed as a flat package.

The steam blocking means 40 includes a cooling body 41, a steam exhaust pipe 45 and an exhaust container 46. The body 41 forms the cooling chamber 42 in which ice, snow or water is filled, and inlet 43 to input the cooling means 44 is formed on one side of the cooling body 41, which can be closed by a cap 43a. The steam exhaust pipe 45 is made of metal and disposed in the cooling chamber 42 of the cooling body 41 with a bent or zigzag form. The both ends of the steam exhaust pipe 45 penetrates the cooling body 41 and are exposed outside the cooling body 41. Then the one end is removably connected to the one end of the first exhaust tube 48, and the other end of the first exhaust tube 48 is connected to the adaptor 48a, which in turn is connected to the pressure regulation valve 15.

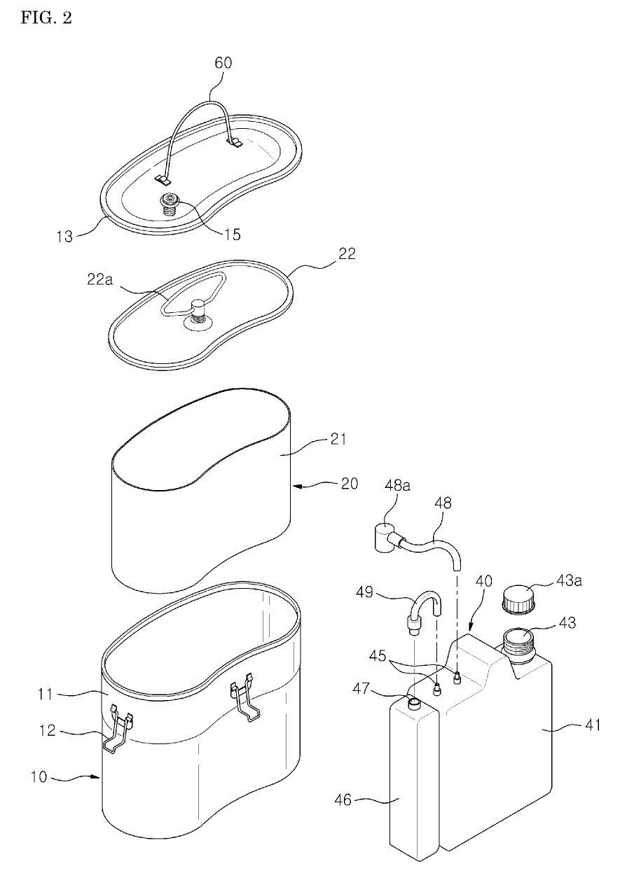

Meanwhile, as shown in FIG. 2, an exhaust container 46 is engaged on one side of the cooling body 31, and has a inlet 47 into which condensed water flows. The exhaust container 46 can be made of plastic material and formed integral with the cooling body 41, or it can be made of separate body against the cooling body 41 and they can be engaged with.

One end of the second exhaust tube 49 is removably connected to the exposed other end of the steam exhaust pipe 45, and the other end of the second exhaust tube 49 is removably connected to the inlet 47 of the exhaust container 46.

In order to prevent the burning by high temperature steam, the first and the second exhaust tubes 48, 49 made of plastic material is preferably used, but the both ends of the steam exhaust pipe 45 can be directly engaged with the steam vent 14 of the outer container 10 and the inlet 47 of the exhaust container 46.

As described above in reference with FIG. 1 to FIG. 3, in the first embodiment of the invention, the outer container 100 houses the inner container 20 and the heating material 30 and the outer lid 13 is air-tightly clamped by the clamping member 12 to the outer container body 11. Then the steam exhaust pipe 45 of the steam blocking means 40 is connected to steam vent 14 of the outer container 10 by use of the first exhaust tube 48 and to the pressure regulation valve by use of the adaptor 48a.

If the heating material 30 is heated, and the foods in the inner container 20 is heated, the generated steam exhausts through steam vent 14 to the cooling chamber 42 of the steam blocking means 40. The exhausted steam passes through the steam exhaust pipe 45 and is condensed by the cooling means 44 filled in the cooling chamber 42 and is collected in the exhaust container 46 as a condensed water. Meanwhile, the steam generated in the inner container 20 can be exhausted by rattling inner lid 22 from the inner container body 21, or separate steam exhaust valve may be provided on the inner lid 22.

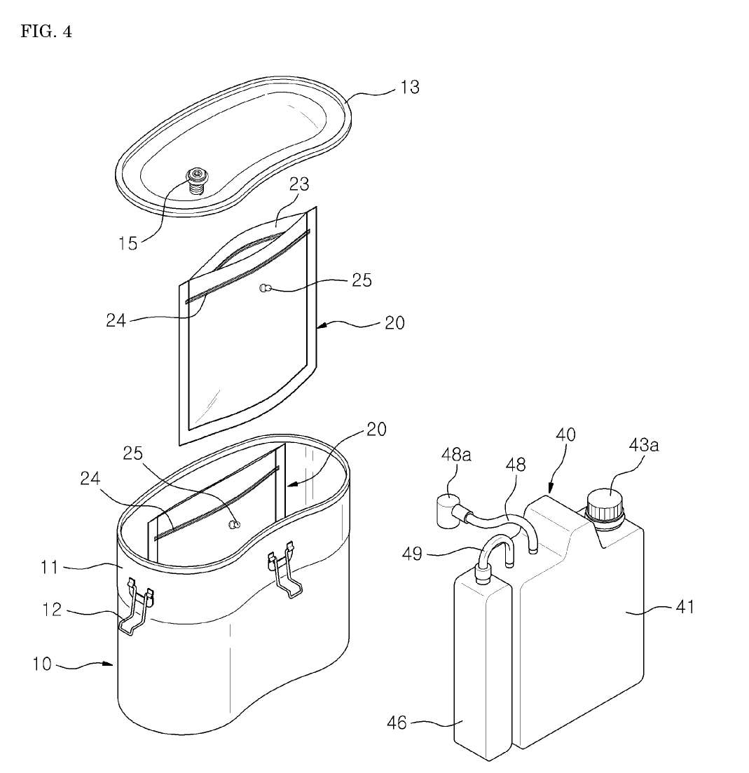

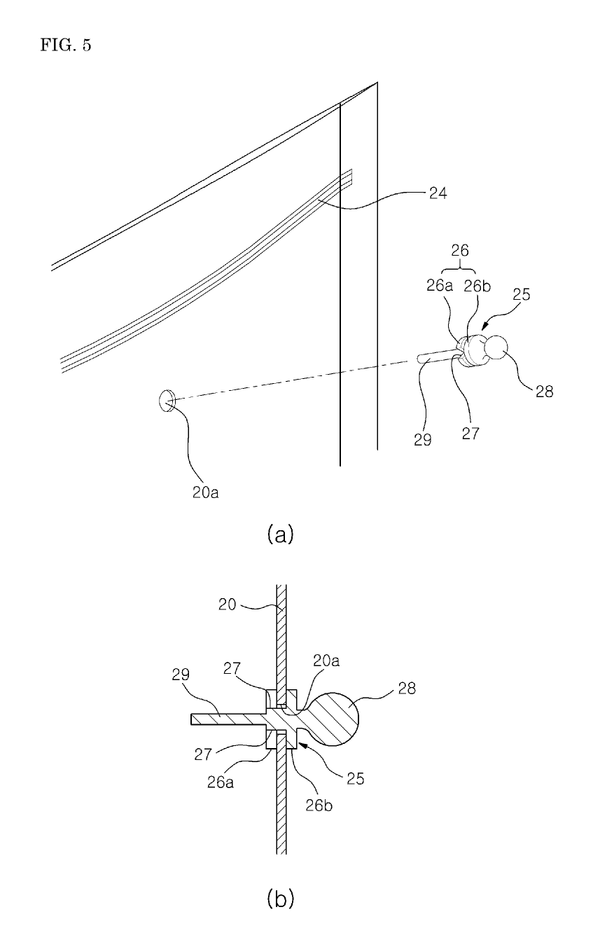

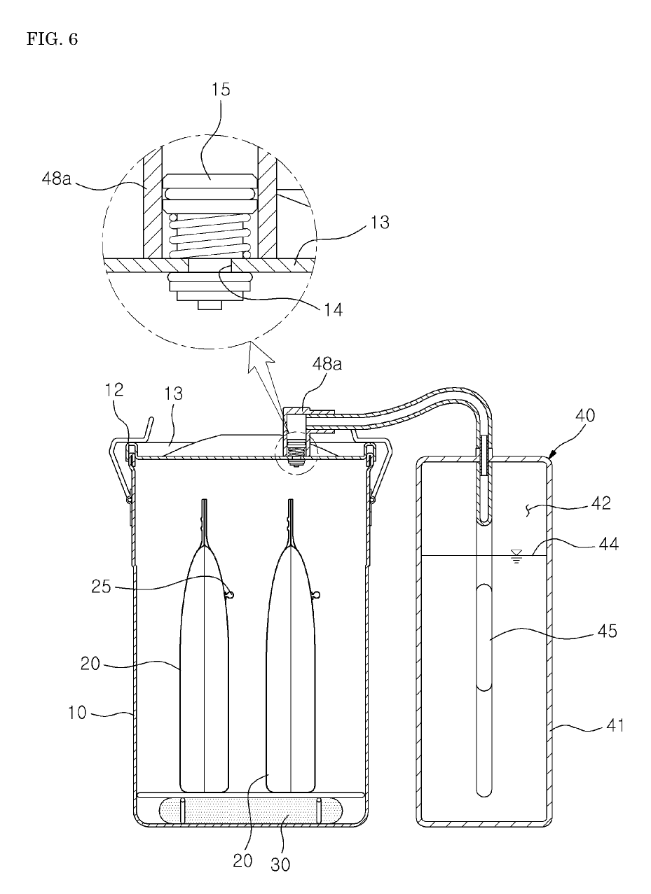

FIG. 4 to FIG. 6 shows the second embodiment of the invention. As shown, the inner lid 20 is made of zipper bag in which the two plastic sheets is bonded to form an envelope or bag having a zipper 24 on the upper opening 23. As shown in FIG. 4 a plural inner containers 20, that is, zipper bags can be inserted in the outer container 10. A hole 20a is formed below the zipper 24 of the inner container 20, and a steam exhaust valve 25 is plugged in the hole 20a. As shown in FIG. 5(a), the steam exhaust valve 24 includes a valve body 26 comprising an inner plate 26a and an outer plate 26b facing each other in the middle part, a ball 28 made of silicon or flexible resin on the outer plate 26b, and an extending bar 29 on the inner plate 26, which can be gripped. As shown in FIG. 5(b), the steam exhaust valve 24 is engaged with the inner container 20 in a manner that the wall surrounding the hole 20a of the inner container 20 is inserted between the inner plate 26a and the outer plate 26b of the steam exhaust valve 25. And a recess 27 is cut in the inner plate 26a, the recess 27 communicates with the hole 20a. If the pressure inside the inner container 20 increase, the steam will exhaust outward through the recess 27 of the steam exhaust valve 25. As shown in FIG. 6, the steam generated in the inner container 20 exhausted through the hole 20a opened by the steam exhaust valve 25 and passes through the first exhaust tube 48 and condensed in the cooling chamber 42 of the steam blocking means 40, and the condensed water is drained to exhaust container 46. Then the steam generated in the outer container is exhausted in the similar passage as mentioned above.

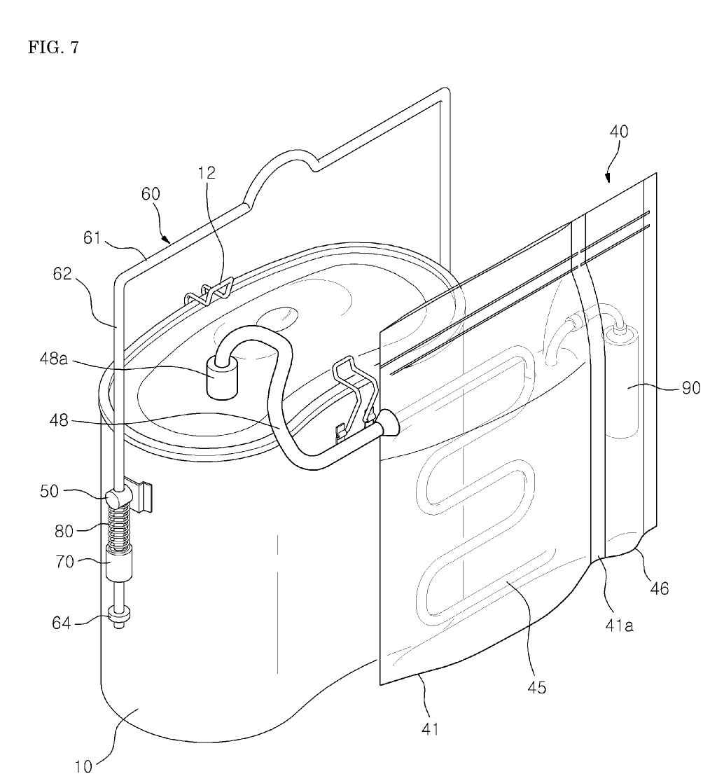

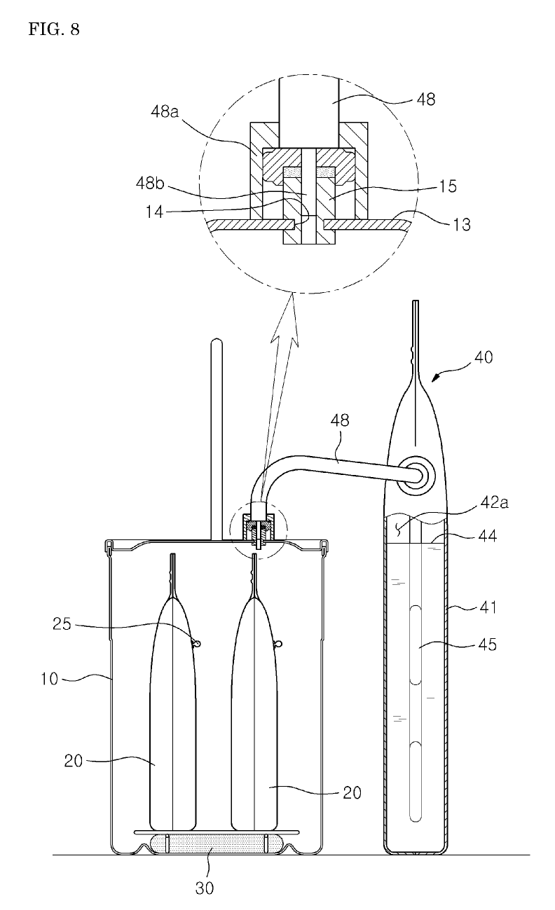

FIG. 7 to FIG. 11 shows the third embodiment of the invention, in which the cooling body 41 of the steam blocking means 40 is formed as a zipper bag having an inlet to put the cooling means 44 in and an outlet to exhaust the condensed water. Then, the exhaust container 46 is also formed as a zipper bag integral with the cooling body 41 but separated by the partition 41a. At the end of the first exhaust tube 48 which is removably connected to the exposed one end of the steam exhaust pipe 45, a metal coupling tip 48b is plugged which is inserted to the steam vent 14 of the outer container 10. And an adaptor 48a is inserted in the end of the first exhaust tube 48 and the pressure regulation valve 15 of the outer container 10 is connected on it.

Meanwhile, the other end of the steam exhaust pipe 45 penetrates the partition 41a of the cooling body 41 to be positioned inside the exhaust container 46, and a noise reducer 90 is coupled on this other end of the steam exhaust pipe 45 to reduce the noise. The noise reducer 90 can be preferably made of porous foam material such as EVA foam. The noise reducer 90 can further reduce the noise during steam exhausting, so it is useful to make the outdoor site more calm and peaceful.

Meanwhile, this embodiment further comprises a handle 60 having a pair of up-down guiders 50 disposed on the opposite outer wall of the outer container 10, a horizontal portion 61 and upright portions 62 bent from the both ends of the horizontal portion 61 and engaged with the up-down guider 50 movably up and down and having a threaded part 63 in the predetermined portion, and a nut body 70 engaged with the threaded part 63 of the upright portion 62 of the handle 60, and a spring inserted on the upright portions 62 between the nut body 70 and the up-down guider 50.

The up-down guider 50 is to guide the up-down movement of the handle 60, and comprises brackets 51 disposed on the opposite side of the wall of the outer container 51 and a hinge 53 hinged on the bracket 51 at one end. The bracket 50 is made of metal pieces with bent both end, welded on the side of the outer container 10 and has an engaging hole 52. The hinge 53 is of cylindrical form, and has an insert hole 54 on one peripheral wall on which the inner wall of the engaging hole 52 is inserted, and a through hole 35 extending diametrically is formed on the other peripheral wall.

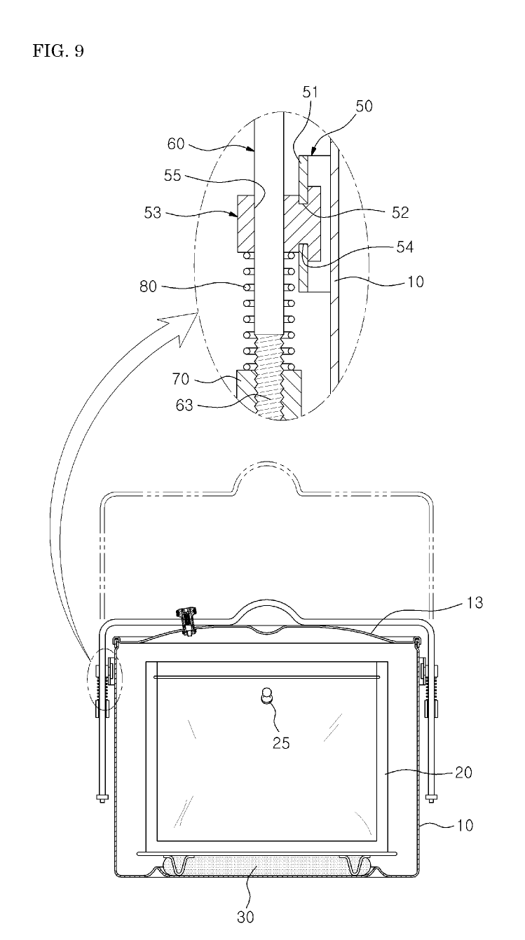

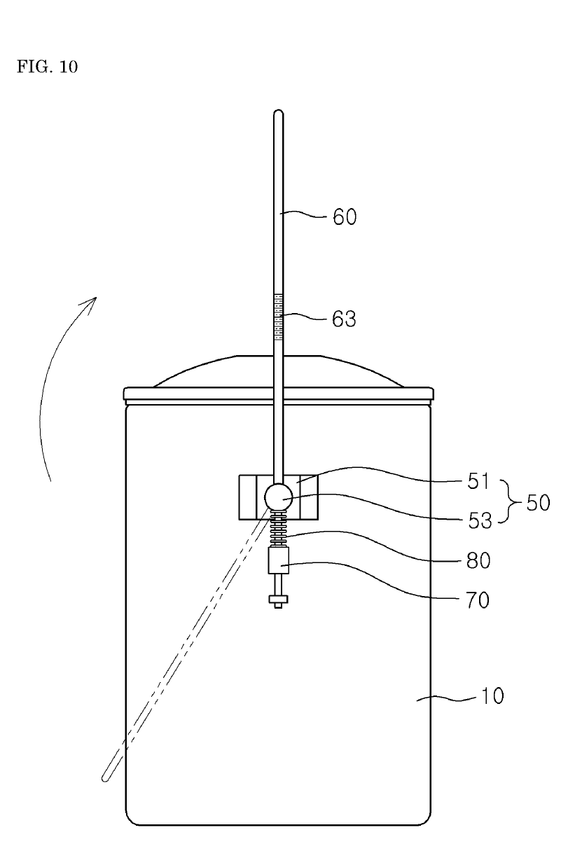

The handle 60 has a horizontal portion 51 and upright portion 62, and the upright portion 62 penetrates the through hole 55 of the hinge 53 of the up-down guider 50, and a blocking plate 64 is provided on the end to prevent from being removed from the through hole 55. The threaded part 63 of the upright portion 62 is formed below the hinge 53 when the horizontal portion 61 is engaged on the outer lid 13 of the outer container 10. The handle 60, as described above and shown in FIG. 9, as the upright portion 62 passes the through hole 55 of the hinge 53, the handle 60 can be moved up and down from the outer container 19. And as the hinge 53 is swung at the bracket 53, the handle 60 can be turned between the upper position and the side position of the outer container 10 as shown in FIG. 10. Accordingly, the volume of the cooking container of the invention can be reduced by turning the handle 60 and it will be easy to carry it, and the opening of the outer container 13 is also easy to enhance the usability.

The outer wall of the nut body 70 can be knurled for user to easily grip and turn. The spring 80 is inserted in the upright portion 62 of the handle 60 and positioned between the hinge 53 and the nut 70 as shown in FIG. 9. If the nut 70 is screwed up, the spring then is compressed, and the horizontal portion 61 of the handle 60 will press the lid 13 of the outer container 10, which will increase the sealing or air-tightness of the lid 13 against the outer container 10.

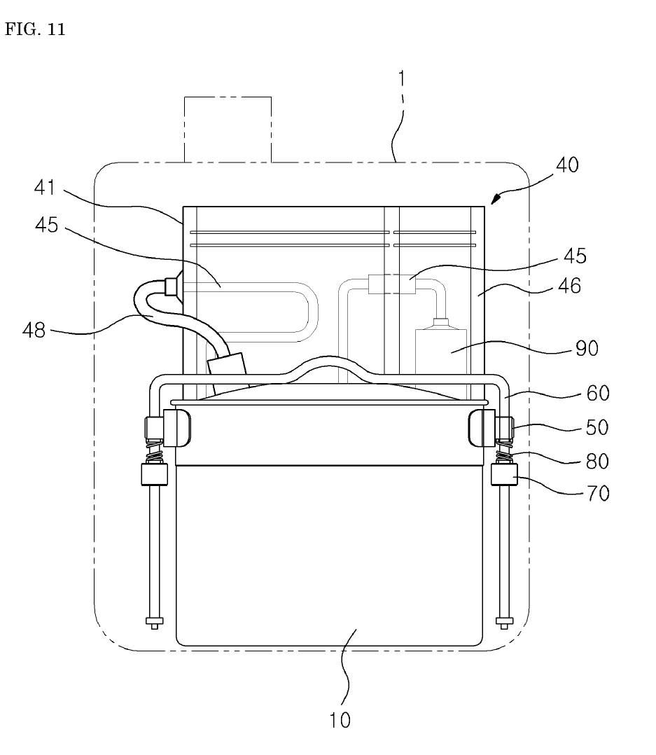

As shown in FIG. 11, the cooking can be carried out while the cooking container is packed in the bag 1 as the steam blocking means 40 being mounted on the outer container 10. Therefore, the user can cook foods during moving or walking, so the cooking time can be saved or reduced.

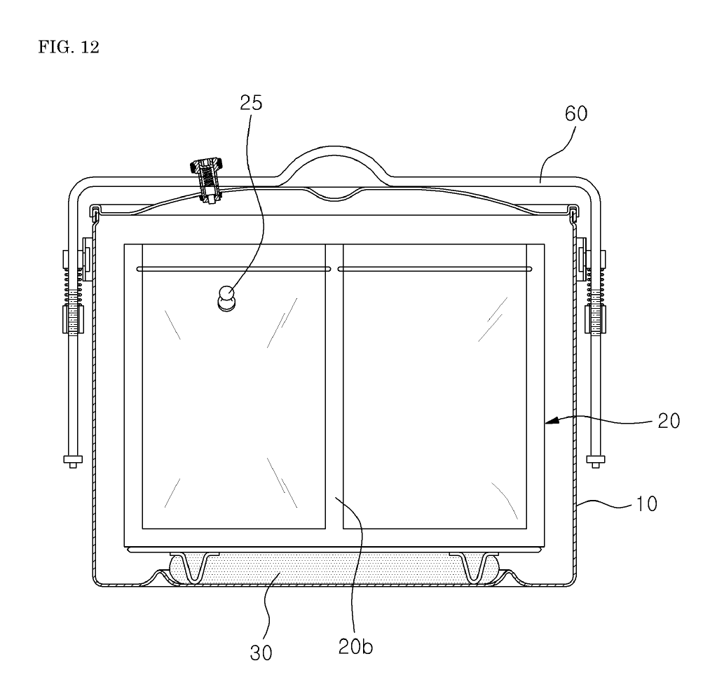

FIG. 12 shows the fourth embodiment of the invention, in which the inner space of the inner container 20 is divided by the partition 20b to form two spaces. So two different foods can be stored separately in the same inner container 20 such as rice and soup. The inner container 20 includes a steam exhaust valve 25, which can be provided on one space or the both spaces of the inner container 10.

The outer container 10 of the embodiments is described as being made of metal material, but it can be made of zipper bag or other type plastic bag.

### INDUSTRIAL APPLICABILITY

The present invention can be used in outdoor activities in the civil or military fields.

1. A cooking container with steam eliminating function comprising:
an outer container 10 to be filled with water and having an openable upper part and a steam vent 14 on one side; an inner container 20 to be filled with foods and being inserted in the outer container 10; a heating material 30 disposed in the outer container 10 and generating heat by reacting with water; a steam blocking means 40 including a cooling body 41 having a cooling chamber 42a to be filled with cooling means 44 such as ice, snow or water, and a steam exhaust pipe 45 provided in the cooling chamber 42a of the cooling body 41 and a part of it being exposed outside of the cooling body 41 and the exposed end of it being removably engaged into the steam vent 14 of the outer container 10, wherein the steam generated in the outer container 10 flow through the steam exhaust pipe 45 and condensed by the cooling means 44 in the cooling chamber 44.

2. A cooking container with steam eliminating function of claim 1, wherein at least the inner container 20 among the outer and inner container 10, 20 comprises a zipper bag having a zipper 24 on the upper opening 21 and a steam exhaust valve 25 below the zipper 24.

3. A cooking container with steam eliminating function of claim 1, wherein the other end of the steam exhaust pipe 45 of the steam blocking means 40 penetrates the cooling body 41 to be exposed outside, and the exposed end of the steam exhaust pipe 45 is connected to an exhaust container 46 in which the water condensed from the steam is collected.

4. A cooking container with steam eliminating function of claim 1, wherein the cooking container further comprises an outer lid 12 on the upper side of the outer container 10, a pair of up-down guiders 50 disposed on the opposite outer wall of the outer container 10, a handle 60 having a horizontal portion 61 and upright portions 62 bent from the both ends of the horizontal portion 61 and engaged with the up-down guiders 50 movably up and down and having a threaded part 63 in the upright portion, a nut body 70 engaged with the threaded part 63 of the upright portion 62 of the handle 60, and a spring 80 inserted on the upright portions 62 between the nut body 70 and the up-down guider 50.

5. A cooking container with steam eliminating function of claim 2, wherein the other end of the steam exhaust pipe 45 of the steam blocking means 40 penetrates the cooling body 41 to be exposed outside, and the exposed end of the steam exhaust pipe 45 is connected to an exhaust container 46 in which the water condensed from the steam is collected.

6. A cooking container with steam eliminating function of claim 2, wherein the cooking container further comprises an outer lid 12 on the upper side of the outer container 10, a pair of up-down guiders 50 disposed on the opposite outer wall of the outer container 10, a handle 60 having a horizontal portion 61 and upright portions 62 bent from the both ends of the horizontal portion 61 and engaged with the up-down guiders 50 movably up and down and having a threaded part 63 in the upright portion, a nut body 70 engaged with the threaded part 63 of the upright portion 62 of the handle 60, and a spring 80 inserted on the upright portions 62 between the nut body 70 and the up-down guider 50.
